(19) United States
(12) Patent Application Publication
(10) Pub. No.: US 2005/0185285 A1
(43) Pub. Date: Aug. 25, 2005

(54) Projector and zoom adjustment method therefor

(75) Inventor: Noriaki Miyasaka, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/037,160

(22) Filed: Jan. 19, 2005

(30) Foreign Application Priority Data
Jan. 20, 2004 (JP) 2004-011414

(51) Int. Cl. G02B 15/14

(52) U.S. Cl. 359/676

(57) ABSTRACT

A CPU 120 moves a zoom lens 116 to the wide-angle side (step 102). When the end on the wide-angle side is reached, the CPU 120 stops the driving of the zoom lens 116 and starts image projection and imaging (S106). The CPU 120 gradually moves the zoom lens 116 to the telescopic side (S108), and pays attention to the positional relationship between a projection area 204i and a frame 202i of a dedicated screen with frame shown on a imaged image 150 to determine whether a side of the frame 202i of the dedicated screen with frame and a side of the projection area 204i overlap or if a corner of the projection area 204i and a side of the frame 202i of the dedicated screen with frame overlap (S110 and S112). If there is an overlap, the CPU 120 stops driving the zoom lens 116 (S114). It is thereby possible to automatically adjust the size of a projection area projected on a dedicated screen with frame or the like to a desired size without, for example, making a keystone correction.

### BACKGROUND OF THE INVENTION

1. Field of the Invention

The present invention relates to a projector for projecting image light on a projection target on a screen, or the like, to display images, and more particularly relates to a projector that can automatically change the size of the projection area in which the image light is projected to a desired size.

2. Description of the Related Art

For example, when a dedicated screen with frame is hung on a wall in a room, etc., and a projector is placed in the front of the room, it is necessary to make various adjustments such as the zoom adjustment, keystone correction, and the like, such that the projection area of the image light projected by the projector fits in the frame of the dedicated screen. Of these adjustments, the zoom adjustment is carried out by driving a zoom lens, which is one of the projection lenses in the projector, to change the size of the projection area.

Users have traditionally carried out such zoom adjustments by operating a zoom button provided on the operation panel, remote control, etc., of the projector.

Nevertheless, with portable projectors, each time the device was set up, the relative position between it and the dedicated screen with frame potentially changed, so the user had to carry out zoom adjustments as above each time, which was extremely troublesome.

A method for automatically carrying out zoom adjustment, and the like, has therefore been proposed that uses a screen with cross-shaped markers in its four corners and a projector equipped with a camera for imaging the screen as described in Japanese Patent Laid-Open Gazette No. 10-333088.

In more detail, the projector projects a test pattern image having cross-shaped markers in its four corners, similar to that of the screen, onto the screen and the camera of the projector images the screen. Then, the zoom lens is driven and a zoom adjustment automatically made such that the screen markers and the test pattern image markers match in the imaged image.

Nevertheless, the above-mentioned conventional technology is premised on the facts that a keystone correction is already made in the projector, and that the form of the test pattern image projected on the screen is rectangular.

Accordingly, there is the problem that it is not possible to appropriately carry out a zoom adjustment if the keystone correction is not yet made or the projection area projected on the screen is not rectangular.

### SUMMARY OF THE INVENTION

Accordingly, an object of the present invention is to provide a projector which resolves the above-mentioned problem and which can automatically adjust the size of the projection area projected on a dedicated screen with frame, or the like, to a desired size without, for example, a keystone correction being made.

In order to attain at least part of the above and the other related objects, the present invention is directed to a first projector that projects image light on a projection target having a rectangular frame on a surface and displays an image. The first projector includes: a zoom lens capable of changing a size of a projection area on which the image light is projected; a zoom lens drive unit for driving the zoom lens; an imaging unit for imaging at least the projection area; and a control unit, wherein the control unit controls the zoom lens drive unit to drive the zoom lens and change a size of the projection area, and stops driving of the zoom lens, when a corner of the frame in the projection target and a side of the projection area overlap, within an image obtained by imaging using the imaging unit.

In this manner, the first projector drives the zoom lens and changes the size of the projection area, at which time, driving of the zoom lens stops if a corner of a frame in the projection target and a side of the projection area overlap within the imaged image.

Accordingly, according to the first projector, it is possible to automatically adjust the size of the projection area on which a projection target is projected to a desired size regardless of the relative positional relationship between the projector and the projection target, and even if a keystone adjustment is not made.

The present invention is directed to a second projector hat projects image light on a projection target having a rectangular frame on a surface and displays an image. The second projector includes: a zoom lens capable of changing a size of a projection area on which the image light is projected, a zoom lens drive unit for driving the zoom lens, a imaging unit for imaging at least the projection area, and a control unit, wherein the control unit controls the zoom lens drive unit to drive the zoom lens and change a size of the projection area, and stops driving of the zoom lens, when a corner of the projection area and a side of the frame in the projection target overlap, within an image obtained by imaging using the imaging unit.

In this manner, the second projector drives the zoom lens and changes the size of the projection area, at which time, driving of the zoom lens stops if a corner of the projection area and a side of the frame of the projection target overlap within the imaged image. Accordingly, the second projector can bring about effects similar to the first projector.

The present invention is directed to a third projector hat projects image light on a projection target having a rectangular frame on a surface and displays an image. The third projector includes: a zoom lens capable of changing a size of a projection area on which the image light is projected; a zoom lens drive unit for driving the zoom lens; an imaging unit for imaging at least the projection area; and a control unit, wherein the control unit controls the zoom lens drive unit to drive the zoom lens and change a size of the projection area, and stops driving of the zoom lens, when a corner of the frame in the projection target and a corner of the projection area overlap, within an image obtained by imaging using the imaging unit.

In this manner, the third projector drives the zoom lens and changes the size of the projection area, at which time, driving of the zoom lens stops if a corner of the frame in the projection target and a corner of the frame of the projection region area overlap within the imaged image. Accordingly, the third projector can bring about effects similar to the first projector.

The present invention is directed to a fourth projector hat projects image light on a projection target having a rectangular frame on a surface and displays an image. The fourth projector includes: a zoom lens capable of changing a size of a projection area on which the image light is projected; a zoom lens drive unit for driving the zoom lens; an imaging unit for imaging at least the projection area; and a control unit, wherein the control unit controls the zoom lens drive unit to drive the zoom lens and change a size of the projection area, and stops driving of the zoom lens, when a side of the frame in the projection target and a side of the projection area overlap, within an image obtained by imaging using the imaging unit.

In this manner, the fourth projector drives the zoom lens and changes the size of the projection area, at which time, driving of the zoom lens stops if a side of the frame in the projection target and a side of the frame of the projection area overlap within the imaged image. Accordingly, the fourth projector can bring about effects similar to the first projector.

The present invention is directed to a fifth projector hat projects image light on a projection target having a rectangular frame on a surface and displays an image. The fifth projector includes: a zoom lens capable of changing a size of a projection area on which the image light is projected; a zoom lens drive unit for driving the zoom lens; an imaging unit for imaging at least the projection area; and a control unit, wherein the control unit controls the drive unit to drive the zoom lens and change the size of the projection area in a manner so that the size is reduced, and stops driving of the zoom lens, when a side of the frame in the projection target disappears from inside the projection area, within an image obtained by imaging using the imaging unit.

In this manner, the fifth projector drives the zoom lens and changes the size of the projection area in a manner so that the size is reduced, at which time, driving of the zoom lens stops if a side of the frame in the projection target disappears from inside the projection area within the imaged image. Accordingly, the fifth projector can bring about effects similar to the first projector.

In the first through fourth projectors, the above-mentioned control unit may also change the size of the projection area in a manner so that the size is reduced, when changing the size of the projection area.

Also, it is preferable that the control unit controls the zoom lens drive unit to drive the zoom lens such as to position it at an end on a wide-angle side beforehand, in advance of changing the size of the projection area in a manner so that the size is reduced.

In this manner, the size of the projection area is maximized, so subsequently, when the size of the projection area is changed in a manner so that it is reduced, it is possible to drive the zoom lens through the entire drive range (that is, the range from the end on the wide-angle side to the end on the telescopic side) with the drive direction of the zoom lens set in one direction.

The present invention is not limited to modes of a device invention such as the projectors described above, and it is possible to produce modes of a method invention such as a zoom adjustment method. Further, it is possible to produce a variety of modes such as a computer program for constructing methods or devices therefor, a recording method for recording such a computer program, and a data signal for embodying the above-mentioned computer program in a carrier wave.

### BRIEF DESCRIPTION OF THE DRAWINGS

FIG. 1 is a block view showing a projector as an embodiment of the present invention.

FIG. 2 is an explanatory view showing a state where image light is projected on a dedicated screen with frame using the projector of FIG. 1.

FIG. 3 is a flowchart showing a processing procedure for zoom adjustment in the projector of FIG. 1.

FIG. 4 is an explanatory view showing one example of a state where image light is projected on a dedicated screen with frame during zoom adjustment.

FIG. 5 is an explanatory view showing a imaged image obtained by imaging the projection area shown in FIG. 4.

FIGS. 6(a) and (b) are explanatory views comparing actual and imaged images of the positional relationship between the projection area and the frame of the dedicated screen with frame when either condition A or B is satisfied and the zoom lens 116 is in a stopped state.

FIGS. 7(a) and (b) are explanatory views comparing actual and imaged images of the positional relationship between the projection area and the frame of the dedicated screen with frame when either condition A or B is satisfied and the zoom lens 116 is in a stopped state.

FIGS. 8(a) and (b) are explanatory views comparing actual and imaged images of the positional relationship between the projection area and the frame of the dedicated screen with frame when either condition A or B is satisfied and the zoom lens 116 is in a stopped state.

FIGS. 9(a) and (b) are explanatory views comparing actual and imaged images of the positional relationship between the projection area and the frame of the dedicated screen with frame when either condition A or B is satisfied and the zoom lens 116 is in a stopped state.

FIGS. 10(a) and (b) are explanatory views comparing actual and imaged images of the positional relationship between the projection area and the frame of the dedicated screen with frame when either condition A or B is satisfied and the zoom lens 116 is in a stopped state.

FIGS. 11(a) and (b) are explanatory views comparing actual and imaged images of the positional relationship between the projection area and the frame of the dedicated screen with frame when either condition A or B is satisfied and the zoom lens 116 is in a stopped state.

FIGS. 12(a) and (b) are explanatory views comparing actual and imaged images of the positional relationship between the projection area and the frame of the dedicated screen with frame when either condition A or B is satisfied and the zoom lens 116 is in a stopped state.

FIGS. 13(a) and (b) are explanatory views comparing actual and imaged images of the positional relationship between the projection area and the frame of the dedicated screen with frame when either condition A or B is satisfied and the zoom lens 116 is in a stopped state.

FIG. 14 is an explanatory view showing another example of a state where image light is projected on a dedicated screen with frame during zoom adjustment.

FIG. 15 is an explanatory view showing a imaged image obtained by imaging the projection area shown in FIG. 14.

FIGS. 16(a) and (b) are explanatory views comparing actual and imaged images of the positional relationship between the projection area and the frame of the dedicated screen with frame when either condition A or B is satisfied and the zoom lens 116 is in a stopped state.

FIGS. 17(a) and (b) are explanatory views comparing actual and imaged images of the positional relationship between the projection area and the frame of the dedicated screen with frame when either condition A or B is satisfied and the zoom lens 116 is in a stopped state.

FIGS. 18(a) and (b) are explanatory views comparing actual and imaged images of the positional relationship between the projection area and the frame of the dedicated screen with frame when either condition A or B is satisfied and the zoom lens 116 is in a stopped state.

FIGS. 19(a) and (b) are explanatory views comparing actual and imaged images of the positional relationship between the projection area and the frame of the dedicated screen with frame when either condition A or B is satisfied and the zoom lens 116 is in a stopped state.

FIG. 20 is an explanatory view showing a different example of a state where image light is projected on a dedicated screen with frame during zoom adjustment.

FIG. 21 is an explanatory view showing a imaged image obtained by imaging the projection area shown in FIG. 20.

FIGS. 22(a) and (b) are explanatory views comparing actual and imaged images of the positional relationship between the projection area and the frame of the dedicated screen with frame when either condition A or B is satisfied and the zoom lens 116 is in a stopped state.

FIGS. 23(a) and (b) are explanatory views comparing actual and imaged images of the positional relationship between the projection area and the frame of the dedicated screen with frame when either condition A or B is satisfied and the zoom lens 116 is in a stopped state.

### DESCRIPTION OF THE PREFERRED EMBODIMENTS

Embodiments for working the present invention are described below based on the embodiments in the following sequence:
1. Construction of the Projector
2. Image Projection Operation
3. Zoom Adjustment Operation
4. Other Examples of the Positional Relationship of the Projection Area and the Frame
5. Effects of the Embodiments
6. Examples of Variations
   6-1. Variation 1
   6-2. Variation 2
   6-3. Variation 3
   6-4. Variation 4
   6-5. Variation 5
      1. Construction of the Projector:

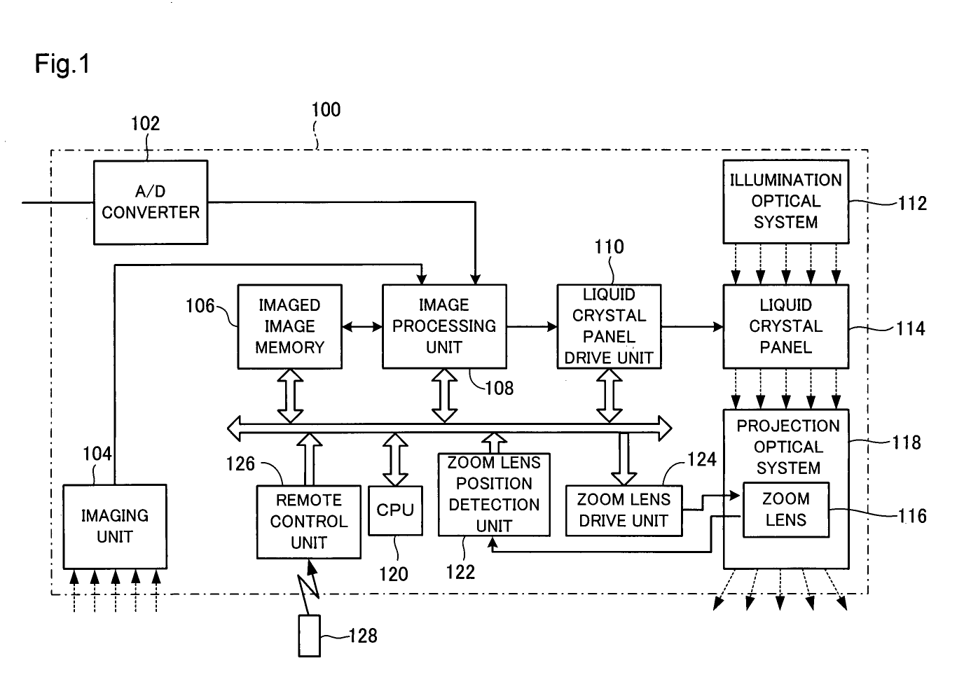

FIG. 1 is a block view showing the construction of a projector as an embodiment of the present invention. The projector 100 is a portable type, and is equipped with a projection optical system 118 having an A/D converter 102, a imaging unit 104, a imaged image memory 106, an image processing unit 108, a liquid crystal panel drive unit 110, an illumination optical system 112, a liquid crystal panel 114, and a zoom lens 116; a CPU 120; a zoom lens position detection unit 122; a zoom lens drive unit 124; a remote control unit 126; and a remote control 128 as shown in FIG. 1. In FIG. 1, the CPU 120 is depicted as being connected only to the image memory 106, the image processing unit 108, the liquid crystal panel drive unit 110, the zoom lens position detection unit 122, the zoom lens drive unit 124, and the remote control unit 126 through a bus, but in actuality, it is connected to other components as well.

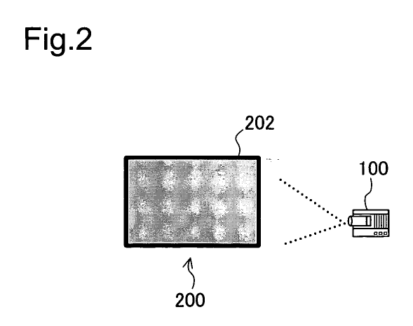

FIG. 2 is an explanatory view showing a state where image light is projected on a dedicated screen with frame using the projector of FIG. 1. In the present embodiment, a dedicated screen with frame 200 is hung beforehand as shown in FIG. 2 on a wall of a room, or the like, as a projection target. The dedicated screen with frame 200 is black on the screen surface and has a frame 202 comprising a rectangular shape, and regions inside and outside the frame 202 are white.

Then, the projector 100 shown in FIG. 1 transported by the user is set up with a suitable distance in front of the dedicated screen with frame 200. At this time, zoom adjustments, a characteristic part of the present invention, is automatically carried out. This zoom adjustment operation is described in detail later below. After various adjustments such as this zoom adjustment are complete, the projector 100 projects image light facing the dedicated screen with frame 200 so an image is displayed in the frame 202 of the dedicated screen with frame 200.

2. Image Projection Operation

Next, the image projection operation, an ordinary operation of the projector 100, is described briefly.

In FIG. 1, when the user using the remote control 128 makes an instruction for image projection to start, the remote control 128 transmits that inputted instruction to the remote control unit 126 using wireless communication. The remote control unit 126 transmits the instruction from the remote control 128 to the CPU 120 through a bus. The CPU 120 controls the components such as the image processing unit 108 based on those instructions, carrying out the image projection operation.

Image signals outputted from a video player, television, DVD player, or the like, or image signals outputted from a personal computer, or the like, are inputted to the A/D converter 102, which converts the analog image signals to digital image signals and outputs them to the image processing unit 108. The image processing unit 108 adjusts the inputted digital image signals such that the display states (for example, the brightness, contrast, synchronicity, tracking, color depth, color shade, and the like) of the image are as desired, and outputs them to the liquid crystal panel drive unit 110.

The liquid crystal panel drive unit 110 drives the liquid crystal panel 114 based on the inputted digital image signal. The illumination light emitted from the illumination optical system 112 is thereby modulated in the liquid crystal panel 114 in accordance with the image information. The projection optical system 118 is attached at the front of a cabinet for the projector 100, and the light modulated by the liquid crystal panel 114 is projected on the dedicated screen with frame 200 as image light. An image is thereby displayed in the frame 202 of the dedicated screen with frame 200.

3. Zoom Adjustment Operation:

Next, the zoom adjustment operation, a characteristic part of the present invention, of the projector is described in detail.

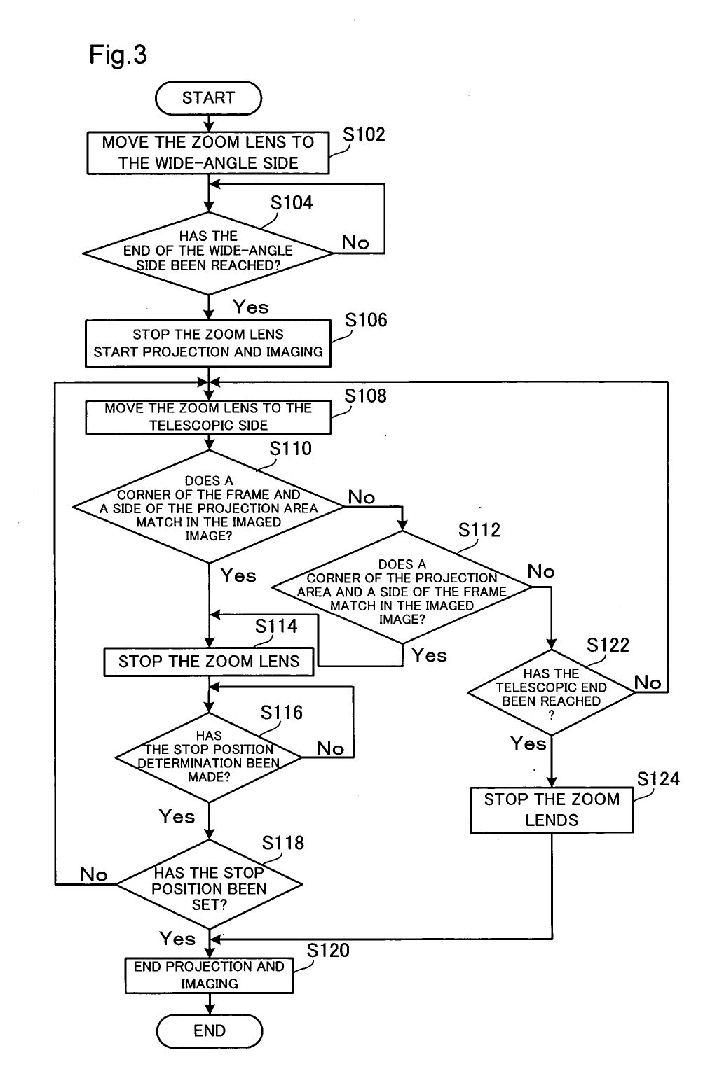

After setting up the projector 100 at a desired location in front of the dedicated screen with frame 200, the user using the remote control 128 makes an instruction for the zoom adjustment to begin, the remote control 128 transmits that inputted instruction to the remote control unit 126 through wireless communication. The remote control unit 126 transmits the instruction from the remote control 128 to the CPU 120 through the bus. In accordance with that instruction, the CPU 120 reads and executes a zoom adjustment processing program from a memory, not illustrated. In further detail, the CPU 120 carries out the zoom adjustment operation by controlling components including the image processing unit 108 according to a processing procedure shown in FIG. 3.

FIG. 3 is a flowchart showing a processing procedure for zoom adjustment in the projector of FIG. 1.

When the processing shown in FIG. 3 starts, the CPU 120 drives the zoom lens 116 provided in the projection optical system 118 by controlling the zoom lens drive unit 124, and the zoom lens 116 is moved to the wide-angle side (step S102). Then, the zoom lens position detection unit 122 detects the position of the zoom lens 116 and transmits the results of the detection to the CPU 120. The CPU 120 determines whether the zoom lens 116 has reached the end on the wide-angle side based on the results of the detection (step S104), and waits for it to reach there. When the zoom lens 116 reaches the end on the wide-angle side, the CPU 120 controls the zoom lens drive unit 124 to stop the drive for the zoom lens 116, and controls the image processing unit 108, imaging unit 104, and the like, to start image projection and imaging (step S106).

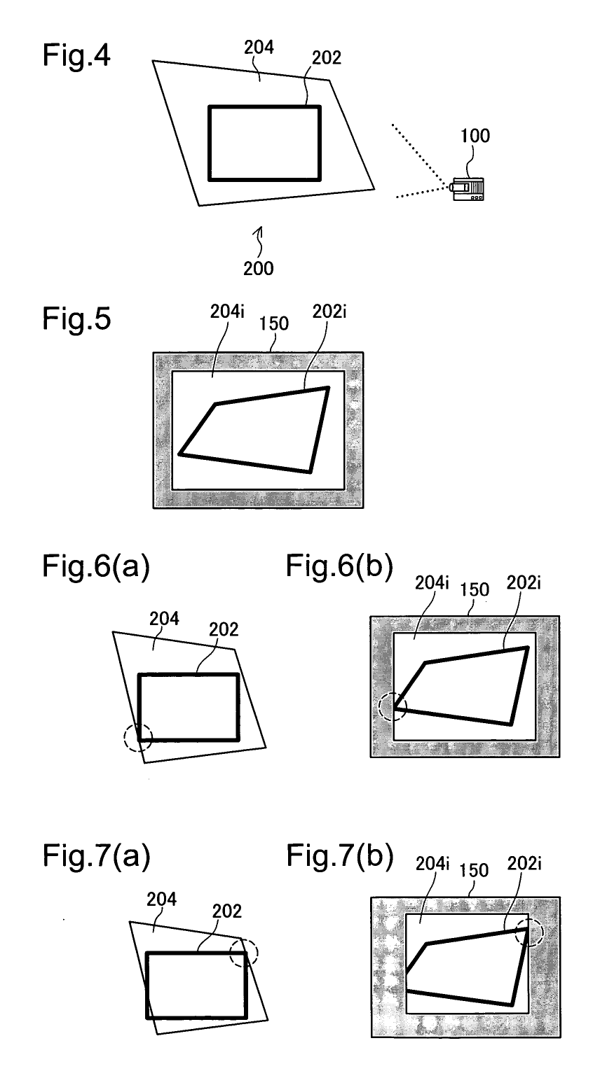

In further detail, the image processing unit 108 generates a pattern image for zoom adjustment, and outputs it to the liquid crystal panel drive unit 110 as a digital image signal. A rectangular white image that is completely white may be used, for example, as the pattern image for zoom adjustment. As described above, the liquid crystal panel drive unit 110 drives the liquid crystal panel 114 based on the inputted digital image signals, and the liquid crystal panel 114 modulates the illumination light emitted from the illumination optical system 112 in accordance with the image information. The projection optical system 118 projects the light modulated by the liquid crystal panel 114 to the dedicated screen with frame 200 as image light through the zoom lens 116, and the like. A pattern image for zoom adjustment is thereby displayed on the dedicated screen with frame 200 as shown in FIG. 4.

FIG. 4 is an explanatory view showing one example of a state where image light is projected on a dedicated screen with frame during zoom adjustment. The pattern image for zoom adjustment displayed in the dedicated screen with frame 200 is a white image that is completely white, and the scope of the display is the projection area 204 where image light from the projector 100 is projected as shown in FIG. 4. In this example, the projector 100 is set up below and to the right of and facing the front of the dedicated screen with frame 200, so the projection area 204 extends in the direction from bottom right to top left facing the frame 202 of the dedicated screen with frame 200. That is, the form of the projection area 204 is warped because of the conventional rectangular shape due to projection of the image light onto the dedicated screen with frame 200 in a diagonal direction, and the so-called keystone occurs.

At this time, the zoom lens 116 is positioned at the end on the wide-angle side, so the size of the projection area 204 is at its maximum. All of the frame 202 of the dedicated screen with frame 200 fits inside the projection area 204.

Meanwhile, the imaging unit 104 is attached to the projector 100 unit such that the center of the projection area 204 comes nearly to the center of the imaged image due to the image light from the projector 100. The imaged image obtained through imaging by the imaging unit 104 is thus as shown in FIG. 5.

FIGS. 5(a) and (b) are explanatory views showing a imaged image obtained by imaging the projection area shown in FIG. 4. As shown in FIG. 5, the center of a projection area 204i comes nearly to the center of a imaging screen in the imaged image 150. Also, the imaging unit 104 faces in the same direction as the projection optical system 118, so the shape of the projection area 204i is rectangular, the same as the shape of the pattern image for zoom adjustment projected from the projection optical system 118. The imaging unit 104 images from a direction diagonal to the dedicated screen with frame 200, so the shape of the frame 202i of the dedicated screen with frame 200 is distorted beyond a rectangular shape. In order to differentiate between the frame of the projection area on which the imaged image 150 is shown and the dedicated screen with frame, and the frame of the actual projected area and the dedicated screen with frame in the explanation, “i” will be attached to the number for the frame of the projection area on which projection is shown and the dedicated screen with frame.

In this manner, the imaging unit 104 images the projection area 204, and the imaged image 150 obtained by imaging is output to the image processing unit 108 as digital image signals. The image processing unit 108 carries out processing such as binary conversion and contouring extraction on the inputted digital image signals, which are then written to the imaged image memory 106 whose contents will subsequently be updated.

Next, the CPU 120 controls the zoom lens drive unit 124 to drive the zoom lens 116, gradually moving the zoom lens 116 this time to the telescopic side (step S108). When the zoom lens 116 is moved to the telescopic side, the size of the projection area 204 displayed on the dedicated screen with frame 200 gradually shrinks. At this time, the CPU 120 monitors the contents of the updated imaged image memory 106, ascertaining changes to the imaged image 150. Then, the CPU 120 concentrates on the positional relationship between the projection area 204i on which the imaged image 150 is shown and a frame 202i of the dedicated screen with frame, and determines whether either condition A or B shown below is satisfied (steps S110 and S112).

A. A corner of the frame 202i for the dedicated screen with frame and a side of the projection area 204i overlap (step S110).

B. A corner of the projection area 204i and a side of the frame 202i of the dedicated screen with frame overlap (step S112).

When making a determination, the sides of the projection area 204i are treated to include corners placed on both ends, and the sides of the frame 202i of the dedicated screen with frame to include corners positioned on both ends.

If neither of the conditions A or B is satisfied in the determination, the CPU 120 determines whether the zoom lens 116 has reached the end on the telescopic side based on the results of the detection obtained from the zoom lens position detection unit 122 (step S122). If it has not, the CPU 120 continues driving the zoom lens 116 to move the zoom lens 116 further to the telescopic side (step S108), and makes a determination whether either condition A or B is satisfied (steps S110 and S112); and this process is repeated.

If the results of the determination is that either condition A or B has been satisfied, the CPU 120 controls the zoom lens drive unit 124 to stop the driving of the zoom lens 116 (step S114).

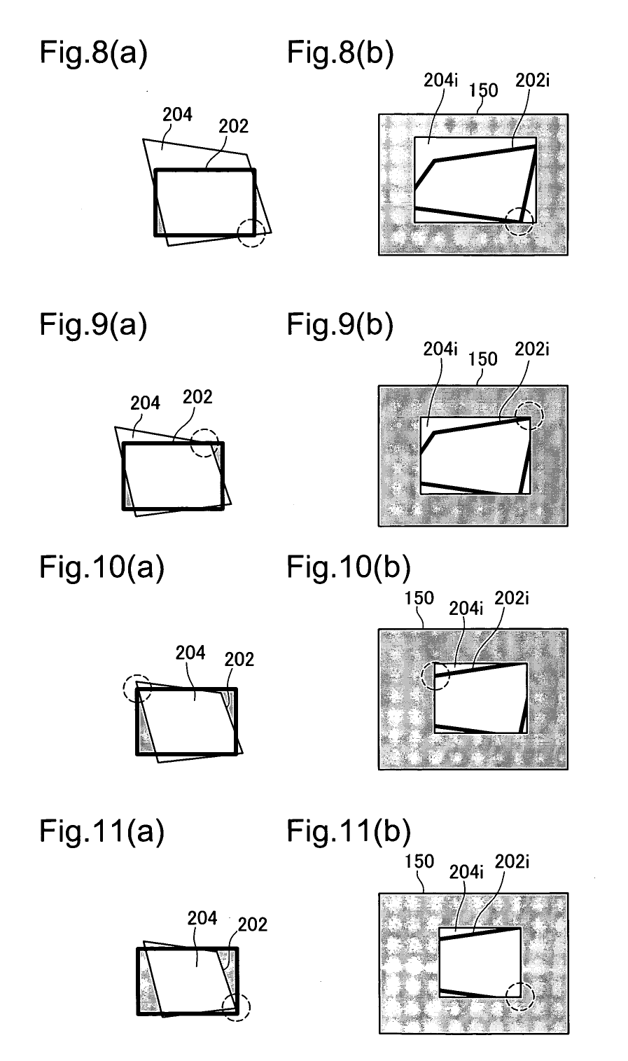

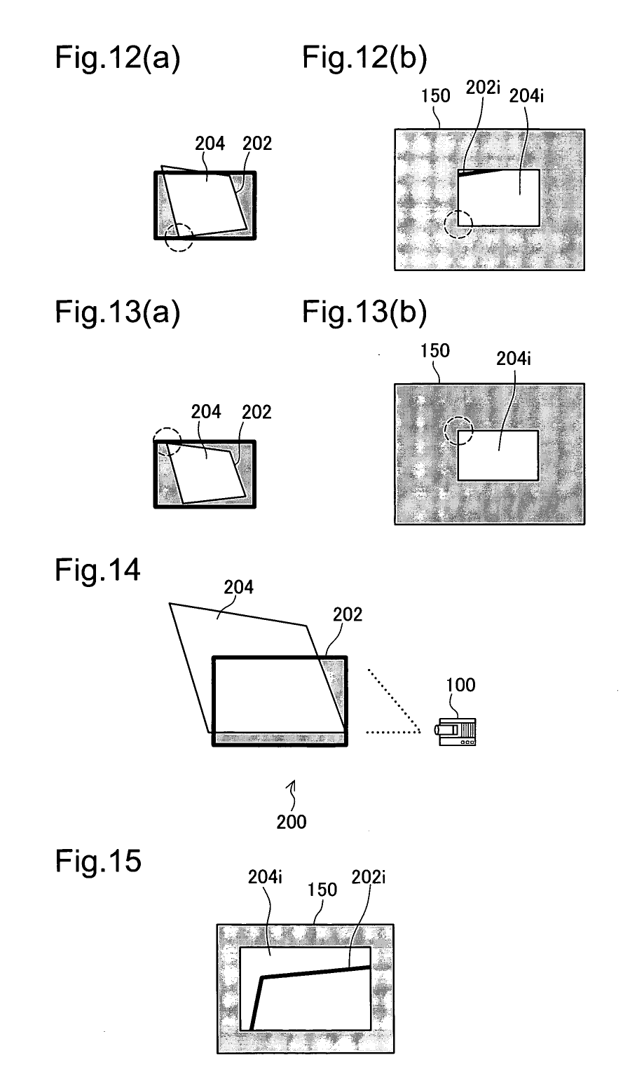

FIGS. 6 to 13 are explanatory views comparing actual and imaged images of the positional relationship between the projection area and the frame of the dedicated screen with frame when either condition A or B is satisfied and the zoom lens 116 is in a stopped state.

In these figures, (a) shows the positional relationship between the projection area 204 and the frame 202 in an actual dedicated screen with frame 200, and (b) shows the positional relationship of the projection area 204i and the frame 202i in a imaged image 150. Also, the zoom lens 116 gradually moves from the wide-angle side to the telescopic side sequentially from FIG. 6 to FIG. 13.

For example, as shown in (b) in FIG. 6, the bottom left corner facing the frame 202i in the imaged image 150 overlaps with the left side of the projection area 204i facing it, so condition A is satisfied, and driving of the zoom lens 116 is stopped in this state. At this time, the frame 202 and the projection area 204 in the actual dedicated screen with frame 200 have a positional relationship as shown in (a). In the figures, dotted circles shown the overlapping portion.

Also, for example, as shown in (b) in FIG. 9, the top right corner of the projection area 204i facing it in the imaged image 150 overlaps the top side of the frame 202 of the dedicated screen with frame, so condition B is satisfied, and driving of the zoom lens 116 is stopped in this state. At this time, the frame 202 and the projection area 204 in the actual dedicated screen with frame 200 have a positional relationship as shown in (a).

In FIGS. 6 to 13, FIGS. 6, 7, 8, and 10 are cases where condition A is satisfied, and the remaining FIGS. 9, 11, 12, and 13 are cases where condition B is satisfied.

If either condition A or B is thus satisfied and driving of the zoom lens 116 is stopped, the CPU 120 places zoom adjustment processing on hold until a stop position determination made separately is carried out (step S169).

The CPU 120 carries out processing described next in detail as a stop position determination. That is, the CPU 120 reads and executes a keystone correction processing program this time from a memory, not illustrated, and carries out the prescribed keystone correction. Although a variety of keystone correction methods are possible, they do not directly relate to the present invention, and so their explanation is omitted. The CPU 120 determines from the results of the keystone correction whether the entire projection area 204 is in the frame 202i of the dedicated screen with frame in the imaged image 150. If the results of the determination are that it is in, the CPU 120 sets the stop position of the zoom lens 116 at that time as the final stop position. If it is not, the results from the keystone correction are cancelled, and a return is made to the state before the keystone correction.

In this manner, when the stop position determination is made, the CPU 120 re-starts zoom adjustment processing, and determines whether the current stop position of the zoom lens 116 was fixed as the final stopping position or not (step S118). Next, if the results of the determination is that it is the final stop position, processing proceeds to step S120, but if it is not, the processing returns to step S108, the zoom lens drive unit 124 is controlled to again drive the zoom lens 116, and the zoom lens 116 is gradually moved from the current stop position to the telescopic side. The CPU 120 repeats the processing below.

In step S122, when the zoom lens 116 reaches the end on the telescopic side, the CPU 120 controls the zoom lens drive unit 124 and stops the driving of the zoom lens 116 (step S124).

When the stop position of the zoom lens 116 has thus been set to the final stop position, or the zoom lens 116 reaches the end on the telescopic side and stops, the CPU 120 controls the image processing unit 108, the imaging unit 104, and the like, completing image projection and imaging (step S120), and the series of zoom adjustment processing shown in FIG. 3 ends.

4. Other Examples of the Positional Relationship of the Projection Area and the Frame

However, due to the relative positional relationship between the projector 100 and the dedicated screen with frame 200 when setting the projector 100 in front of the dedicated screen with frame 200, the form of the projection area 204 displayed on the dedicated screen with frame 200 and the form of the frame 202i of the dedicated screen with frame on which the imaged image 150 is projected differ when the image projection or imaging begins in step S106, so subsequently, the positional relationship of the projection area and the frame of the dedicated screen with frame also differ when the zoom lens 116 moves to the telescopic side and is stopped at the point when either condition A or B is satisfied.

FIG. 14 is an explanatory view showing another example of a state where image light is projected on a dedicated screen with frame during zoom adjustment. FIG. 15 is an explanatory view showing a imaged image obtained by imaging the projection area shown in FIG. 14. As in FIGS. 4 and 5 described above, these drawings show the state when image projection and imaging have begun in step S106.

In this example as well, the projector 100 is set in front of the dedicated screen with frame 200 below and to the right facing it as in FIGS. 4 and 5, so the projection area 204 extends from the bottom right to the top left of the frame 202 of the dedicated screen with frame 200 facing it as shown in FIG. 14. Unlike FIGS. 4 and 5, however, a part of the frame 202 of the dedicated screen with frame 200 sticks out from the projection area 204 as shown in FIGS. 14 and 15.

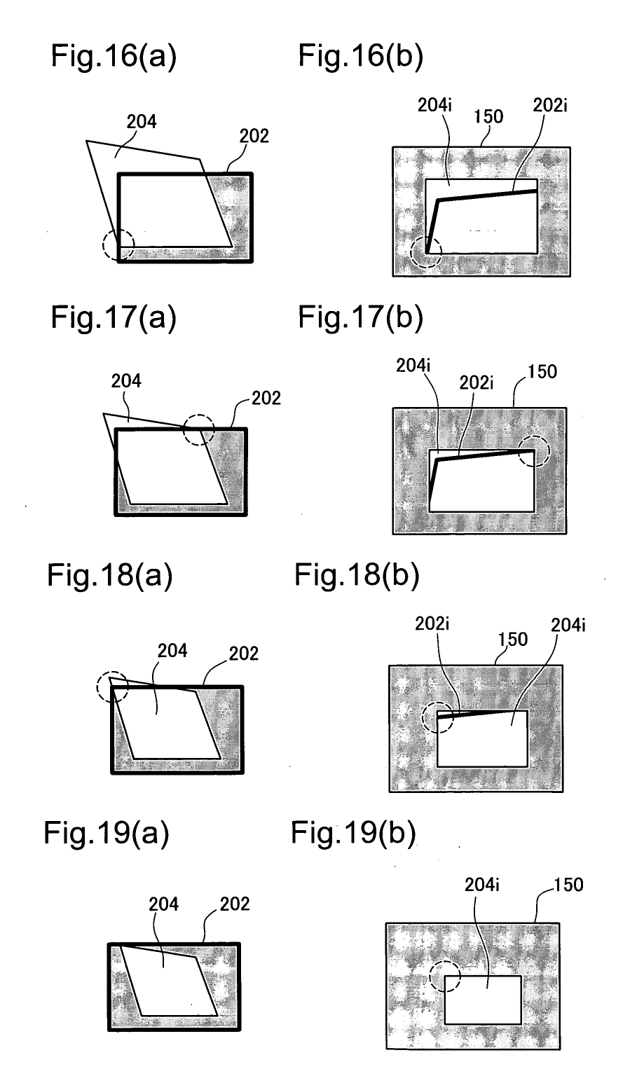

Accordingly, either condition A or B is satisfied in this case, and the positional relationship of the projection area and the frame of the dedicated screen with frame when driving of the zoom lens 116 is stopped in step S114 is as shown in FIGS. 16 to 19.

FIGS. 16 to 19 are explanatory views comparing actual and imaged images of the positional relationship between the projection area and the frame of the dedicated screen with frame when either condition A or B is satisfied and the zoom lens 116 is in a stopped state.

Also in these figures, (a) shows the positional relationship between the projection area 204 and the frame 202 in an actual dedicated screen with frame 200, and (b) shows the positional relationship between the projection area 204i and the frame 202i in the imaged image 150. Also, the zoom lens 116 gradually moves from the wide-angle side to the telescopic side in sequence from FIG. 16 to FIG. 19. In these figures, FIG. 18 is the case where condition A (a corner of the frame 202i and a side of the projection area 204i overlap) is satisfied, and the remaining FIGS. 16, 17, and 19 are the case where condition B (a corner of the projection area 204i and a side of the frame 202i overlap) is satisfied.

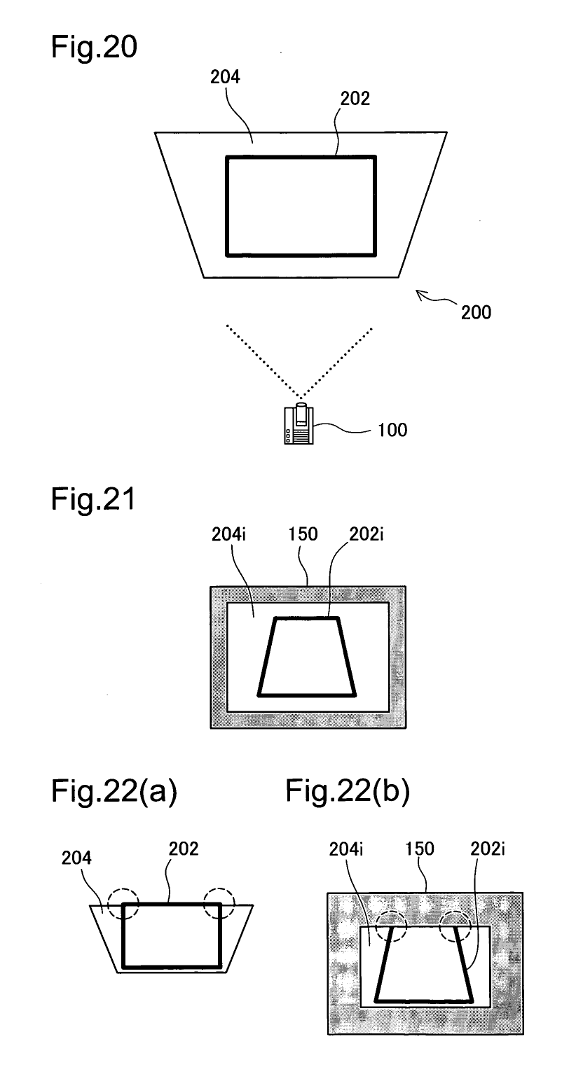

FIG. 20 is an explanatory view showing a different example of a state where image light is projected on a dedicated screen with frame during zoom adjustment. FIG. 21 is an explanatory view showing a imaged image obtained by imaging the projection area shown in FIG. 20. As in FIGS. 4 and 5 described above, these drawings show the state when image projection and imaging have begun in step S106.

Unlike in FIGS. 4 and 5, in this example, the projector 100 is set lower than the direct front of the dedicated screen with frame 200, so the projection area 204 extends upwards on the frame 202 of the dedicated screen with frame 200 to form a trapezoid as shown in FIG. 20. However, as in FIGS. 4 and 5, the entirety of the frame 202 of the dedicated screen with frame 200 fits in the projection area 204 as shown in FIGS. 20 and 21.

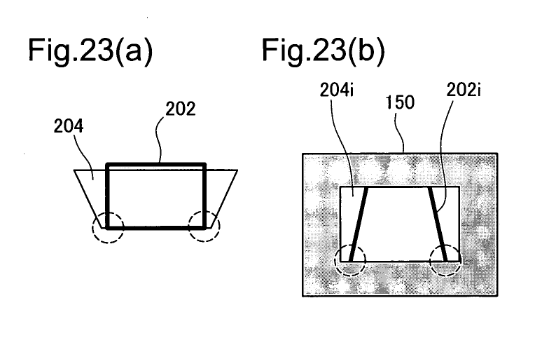

Accordingly, in this case, either condition A or B is satisfied, and the positional relationship of the projection area and the frame of the dedicated screen with frame is as shown in FIGS. 22 and 23 when driving of the zoom lens 116 is stopped in step S114.

FIGS. 22 and 23 are explanatory views comparing actual and imaged images of the positional relationship between the projection area and the frame of the dedicated screen with frame when either condition A or B is satisfied and the zoom lens 116 is in a stopped state.

In these figures, (a) shows the positional relationship between the projection area 204 and the frame 202 in an actual dedicated screen with frame 200, and (b) shows the positional relationship between the projection area 204i and the frame 202i in the imaged image 150. Also, the zoom lens 116 gradually moves from the wide-angle side to the telescopic side in sequence from FIG. 22 to FIG. 23.

In FIG. 22, the top left and top right corners of the frame 202i of the dedicated screen with frame overlaps the top side of the projection area 204i in the imaged image 150 as shown in (b), so condition A is satisfied, and driving of the zoom lens 116 is stopped in this state. At this time, the frame 202 and the projection area 204 have a positional relationship in the actual dedicated screen with frame 200 as shown in (a).

Also, in FIG. 23, the bottom left and bottom right corners of the frame 202i of the dedicated screen with frame facing it overlap the bottom side of the projection area 204i in the imaged image 150 as shown in (b), so in this case as well, condition A is satisfied, and driving of the zoom lens 116 is stopped in this state. At this time, the frame 202 and the projection area 204 have a positional relationship in the actual dedicated screen with frame 200 as shown in (a).

5. Effects of the Embodiments

As described above, according to the present embodiments, the size of the projection area 204 projected on the dedicated screen with frame 200 can be automatically adjusted to the desired size regardless of the relative positional relationship of the projector 100 and the dedicated screen with frame 200 when the projector 100 is set up in front of the dedicated screen with frame 200, and even if, for example, a keystone correction has not been made. Also, after the size of the projection area 204 is adjusted to the desired size, a keystone adjustment may be carried out such that at the end, the entire projected area fits in the frame of the dedicated screen with frame.

6. Examples of Variations

The present invention is not limited to the above-mentioned examples and embodiments, and may be worked in a variety of modes within a scope where the gist is not deviated from.

6-1. Variation 1:

In the embodiments described above, when determining whether either condition A or B is satisfied, a side of the projection area 204i containing a corner positioned at either side as well as a side of the frame 202i of the dedicated screen with frame containing a corner positioned at either end is handled as a stop condition for the zoom lens 116. Accordingly, if a corner of the frame 202i of the dedicated screen with frame and a corner of projection area 204i overlap, condition A or B is satisfied.

However, if a side does not contain a corner positioned at either end, the new condition below may be added as conditions for stopping the zoom lens 116.

C. A corner of the frame 202i of the dedicated screen with frame and the projection area 204i overlap.

Even if the new condition C is thus added, it is possible to automatically adjust the size of the projection area 204 projected on the dedicated screen with frame 200 to the desired size as in the embodiments described above.

6-2. Variation 2:

In the examples in FIGS. 22 and 23 in the embodiments described above, two adjacent corners overlap with one side of the projection area 204 in the frame 202i of the dedicated screen with frame. Accordingly, it is possible to view this as one side of the frame 202i of the dedicated screen with frame as overlapping one side of the projection area 204i. If this view is adopted, introduce the new condition below as a stop condition for the zoom lens 116.

D. A side of the frame 202i of the dedicated screen with frame and a side of the projection area 204i overlap.

Even if the new condition D is thus introduced, it is possible to automatically adjust the size of the projection area 204 projected on the dedicated screen with frame 200 to the desired size as in the embodiments described above.

6-3. Variation 3:

In each of the examples in FIGS. 10 to 13, 18, and 19 in the embodiments described above, the side of the frame 202i of the dedicated screen with frame disappears from inside the projection area 204i in the imaged image 150 as shown in (b). Accordingly, the new condition below may be introduced as a stop condition for the zoom lens 116.

E. A side of the frame 202i of the dedicated screen with frame disappears from inside the projection area 204i.

Even if the new condition E is thus introduced, it is possible to automatically adjust the size of the projection area 204 projected on the dedicated screen with frame 200 to the desired size as in the embodiments described above.

6-4. Variation 4:

In the embodiments described above, the dedicated screen with frame 200 was used as the projection target, but the present invention is not limited thereto.

For example, in a case where the wall of the room is white, a rectangular frame may be colored with a black line using tape, paint, or the like, to make the wall the projection target. A rectangular frame may be drawn with a black line marker on a white board as well to make the white board the projection target.

The colors of the projection target are not limited to black for the frame and white for the inside of the frame and the external area; the frame may be white and the inside of the frame and external area may be black. For example, a rectangular frame may be drawn with white chalk on a blackboard to make the blackboard the projection target.

In that case, the CPU 120 derives a histogram showing the appearance frequency of each pixel value in the imaged image; determines whether pixels that are white or a color near white are common in the overall imaged image or if pixels that are black or a color near black are common; and if there are many pixels that are white or a color near white, may process as in the embodiments described above; and if there are many pixels that are black or a color near black, may reverse the black and white stored in the imaged image memory 106 and process as in the embodiments described above. Also, when the CPU 120 determines whether condition A or B is satisfied, it may reverse the white and black color evaluation criteria.

Also, the present invention is not limited to white and black; as long as the color of the frame and the color in the frame and in the external area have a desired contrast, any color combination may be used for the projection target.

6-5. Variation 5:

In the embodiments described above, when the zoom adjustment processing began, the CPU 120 first moved the zoom lens 116 to the end of the wide-angle side, and then gradually moved it to the telescopic side, but the present invention is not limited thereto; conversely, the CPU 120 may first move the zoom lens 116 to the end of the telescopic side, and then gradually move it to the wide-angle side.

1. A projector that projects image light on a projection target having a rectangular frame on a surface and displays an image, the projector comprising:
a zoom lens capable of changing a size of a projection area on which the image light is projected;
a zoom lens drive unit for driving the zoom lens;
an imaging unit for imaging at least the projection area; and
a control unit,
wherein the control unit controls the zoom lens drive unit to drive the zoom lens and change a size of the projection area, and
stops driving of the zoom lens, when a corner of the frame in the projection target and a side of the projection area overlap, within an image obtained by imaging using the imaging unit.

2. A projector that projects image light on a projection target having a rectangular frame on a surface and displays an image, the projector comprising:
a zoom lens capable of changing a size of a projection area on which the image light is projected,
a zoom lens drive unit for driving the zoom lens,
a imaging unit for imaging at least the projection area, and
a control unit,
wherein the control unit controls the zoom lens drive unit to drive the zoom lens and change a size of the projection area, and
stops driving of the zoom lens, when a corner of the projection area and a side of the frame in the projection target overlap, within an image obtained by imaging using the imaging unit.

3. A projector that projects image light on a projection target having a rectangular frame on a surface and displays an image, the projector comprising:
a zoom lens capable of changing a size of a projection area on which the image light is projected;
a zoom lens drive unit for driving the zoom lens;
an imaging unit for imaging at least the projection area; and
a control unit,
wherein the control unit controls the zoom lens drive unit to drive the zoom lens and change a size of the projection area, and
stops driving of the zoom lens, when a corner of the frame in the projection target and a corner of the projection area overlap, within an image obtained by imaging using the imaging unit.

4. A projector that projects image light on a projection target having a rectangular frame on a surface and displays an image, the projector comprising:
a zoom lens capable of changing a size of a projection area on which the image light is projected;
a zoom lens drive unit for driving the zoom lens;
an imaging unit for imaging at least the projection area; and
a control unit,
wherein the control unit controls the zoom lens drive unit to drive the zoom lens and change a size of the projection area, and
stops driving of the zoom lens, when a side of the frame in the projection target and a side of the projection area overlap, within an image obtained by imaging using the imaging unit.

5. The projector in accordance with claim 1, wherein the control unit changes the size of the projection area in a manner so that the size is reduced.

6. The projector in accordance with claim 2, wherein the control unit changes the size of the projection area in a manner so that the size is reduced, when changing the size of the projection area.

7. The projector in accordance with claim 3, wherein the control unit changes the size of the projection area in a manner so that the size is reduced, when changing the size of the projection area.

8. The projector in accordance with claim 4, wherein the control unit changes the size of the projection area in a manner so that the size is reduced, when changing the size of the projection area.

9. A projector that projects image light on a projection target having a rectangular frame on a surface and displays an image, the projector comprising:
a zoom lens capable of changing a size of a projection area on which the image light is projected;
a zoom lens drive unit for driving the zoom lens;
an imaging unit for imaging at least the projection area; and
a control unit,
wherein the control unit controls the drive unit to drive the zoom lens and change the size of the projection area in a manner so that the size is reduced, and
stops driving of the zoom lens, when a side of the frame in the projection target disappears from inside the projection area, within an image obtained by imaging using the imaging unit.

10. The projector in accordance with claim 5, wherein the control unit controls the zoom lens drive unit to drive the zoom lens such as to position it at an end on a wide-angle side beforehand, in advance of changing the size of the projection area in a manner so that the size is reduced.

11. The projector in accordance with claim 9, wherein the control unit controls the zoom lens drive unit to drive the zoom lens such as to position it at an end on a wide-angle side beforehand, in advance of changing the size of the projection area in a manner so that the size is reduced.

12. A zoom adjustment method for a projector which projects image light on a projection target having a rectangular frame on a surface and displays an image, the method comprising the steps of:
(a) setting up a projector comprising a zoom lens capable of changing the size of the projection area on which the image light is projected and an imaging unit for imaging the projection area as the projector in front of the projection target;
(b) driving the zoom lens and changing a size of the projection area;
(c) determining whether a corner of the frame in the projection target and a side of the projection area overlap within an image obtained by imaging using the imaging unit; and
(d) stopping driving of the zoom lens if the corner of the frame and the side of the projection area overlap.

13. A zoom adjustment method for a projector which projects image light on a projection target having a rectangular frame on a surface and displays an image, the method comprising the steps of:
(a) setting up a projector comprising a zoom lens capable of changing the size of the projection area on which the image light is projected and an imaging unit for imaging the projection area as the projector in front of the projection target;
(b) driving the zoom lens and changing a size of the projection area;
(c) determining whether a corner of the projection area and a side of the frame in the projection target overlap within an image obtained by imaging using the imaging unit; and
(d) stopping driving of the zoom lens if the corner of the projection area and the side of the frame overlap.

14. A zoom adjustment method for a projector which projects image light on a projection target having a rectangular frame on a surface and displays an image, the method comprising the steps of:
(a) setting up a projector comprising a zoom lens capable of changing the size of the projection area on which the image light is projected and an imaging unit for imaging the projection area as the projector in front of the projection target;
(b) driving the zoom lens and changing a size of the projection area;
(c) determining whether a corner of the frame in the projection target and a corner of the projection area overlap within an image obtained by imaging using the imaging unit; and
(d) stopping driving of the zoom lens if the corner of the frame and the corner of the projection area overlap.

15. A zoom adjustment method for a projector which projects image light on a projection target having a rectangular frame on a surface and displays an image, the method comprising the steps of:
(a) setting up a projector comprising a zoom lens capable of changing the size of the projection area on which the image light is projected and an imaging unit for imaging the projection area as the projector in front of the projection target;
(b) driving the zoom lens and changing a size of the projection area;
(c) determining whether a side of the frame in the projection target and a side of the projection area overlap within an image obtained by imaging using the imaging unit; and
(d) stopping driving of the zoom lens if the side of the frame and the side of the projection area overlap.

16. The zoom adjustment method according to claim 12, wherein the step (b) involves changing the size of the projection area in a manner so that the size is reduced, when changing the size of the projection area.

17. The zoom adjustment method according to claim 13, wherein the step (b) involves changing the size of the projection area in a manner so that the size is reduced, when changing the size of the projection area.

18. The zoom adjustment method according to claim 14, wherein the step (b) involves changing the size of the projection area in a manner so that the size is reduced, when changing the size of the projection area.

19. The zoom adjustment method according to claim 15, wherein the step (b) involves changing the size of the projection area in a manner so that the size is reduced, when changing the size of the projection area.

20. A zoom adjustment method for a projector which projects image light on a projection target having a rectangular frame on a surface and displays an image, the method comprising the steps of:
(a) setting up a projector comprising a zoom lens capable of changing the size of the projection area on which the image light is projected and an imaging unit for imaging the projection area as the projector in front of the projection target;
(b) driving the zoom lens and changing a size of the projection area in a manner so that the size is reduced;
(c) determining whether a side of the frame in the projection target disappears from inside the projection area within an image obtained by imaging using the imaging unit; and
(d) stopping driving of the zoom lens if the side of the frame disappears from inside the projection area.

21. The zoom adjustment method according to claim 16, wherein the step (b) includes the step of driving the zoom lens such as to position it at an end on a wide-angle side beforehand, in advance of changing the size of the projection area in a manner so that the size is reduced.

22. The zoom adjustment method according to claim 20, wherein the step (b) includes the step of driving the zoom lens such as to position it at an end on a wide-angle side beforehand, in advance of changing the size of the projection area in a manner so that the size is reduced.
